(19) United States
(12) Patent Application Publication
(10) Pub. No.: US 2013/0183411 A1
(43) Pub. Date: Jul. 18, 2013

(54) COOKED AND SHELF STABLE STEEL CUT OATMEAL IN A CUP

(71) Applicant: Taejin Song, Fullerton, CA (US)

(72) Inventor: Taejin Song, Fullerton, CA (US)

(21) Appl. No.: 13/351,196

(22) Filed: Jan. 16, 2012

(51) Int. Cl. A23L 1/168; B65D 85/72; B65B 55/12

(52) U.S. Cl. 426/106; 426/392; 426/402; 426/619

(57) ABSTRACT

A cooked steel cut oatmeal product is shelf stable and supplied in a cup. The oatmeal product of the present invention allows people to enjoy a healthful steel cut oatmeal without the hassle and time needed for cooking it. The product of the present invention may simply be warmed and ready to eat while retaining its natural taste and texture.

### BACKGROUND OF THE INVENTION

The present invention relates to food products and, more particularly, to cooked and shelf stable steel cut oatmeal.

In today's fast-paced environment, many people look for quick, already prepared meals. However, it is often difficult to find a healthful meal that is also quick and easy to prepare.

Many people enjoy oatmeal; however, there is no shelf stable cooked steel cut oatmeal available. While a few frozen cooked oatmeal products are available, there are no such products that may keep over an extended period of time outside of the freezer.

As can be seen, there is a need for a cooked steel cut oatmeal product that may be shelf stable.

### SUMMARY OF THE INVENTION

In one aspect of the present invention, a method for making a cooked shelf stable oat food product comprises dispensing oats into a container; adding hot water to the container; sealing the container; waiting for the oats to be immersed in the water; cooking and sterilizing the sealed container; and cooling the cooked and sterilized sealed container, wherein the process is carried out without an acidifier.

In another aspect of the present invention, a cooked shelf stable oat food product is made by the process described in the above paragraph.

These and other features, aspects and advantages of the present invention will become better understood with reference to the following drawings, description and claims.

### BRIEF DESCRIPTION OF THE DRAWINGS

FIG. 1 is a flow chat describing a method for making a shelf stable cooked oatmeal according to an exemplary embodiment of the present invention; and

FIG. 2 is a perspective view of a cooked steel cut oatmeal product in a cup, according to an exemplary embodiment of the present invention.

### DETAILED DESCRIPTION OF THE INVENTION

The following detailed description is of the best currently contemplated modes of carrying out exemplary embodiments of the invention. The description is not to be taken in a limiting sense, but is made merely for the purpose of illustrating the general principles of the invention, since the scope of the invention is best defined by the appended claims.

Broadly, an embodiment of the present invention provides a cooked steel cut oatmeal product that may be shelf stable and supplied in a cup. The oatmeal product of the present invention allows people to enjoy a healthful steel cut oatmeal without the hassle and time needed for cooking it. The product of the present invention may simply be warmed and ready to eat while retaining its natural taste and texture.

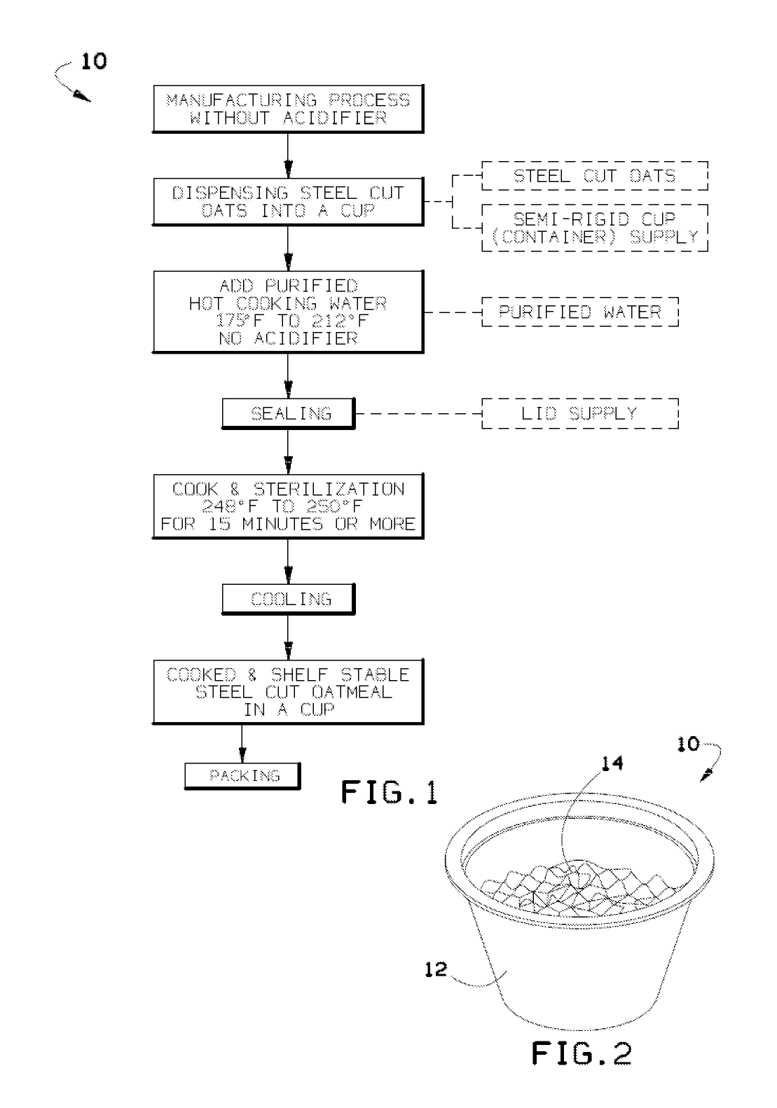

Referring to FIGS. 1 and 2, a method for manufacturing a cooked and shelf stable oatmeal 10 may include a step of dispensing steel cut oats 14 into a cup 12. The cup may be, for example, a semi-rigid cup or container capable of withstanding the manufacturing process described below.

Purified hot cooking water may be added to the oats 14 in the cup 12. The water may be from about 175° F. to about 212° F. In some embodiments, there may be no acidifier used in the process of the present invention.

At this point, the cup 12 may be sealed with a lid. Various methods may be used to attach the lid to the cup. For example, the lid may be a twist-top lid, or the lid may fit about protrusions on the cup. Other lid to cup connections may be contemplated within the scope of the present invention. There may be a waiting period before cooking and sterilization (described below). The waiting period may be used to get the steel cut oats immersed in the hot water. During this time, the inner temperature could be kept above 68° F.

The lid-sealed cup may then to cooked and sterilized at a temperature from about 248° F. to about 250° F., for example, for about 15 minutes or longer. Such a temperature may be achieved, for example, in a water spray retort machine.

When the cooking and sterilization time is complete, the steel cut oats in the cup may be cooked and may then be shelf-stable. A user may then remove or loosen the lid, warm the oatmeal (typically within about a minute in a microwave oven, for example), and the product is ready to eat.

The process of the present invention may be applied to other food products as well. For example, cooked brown rice (porridge) may be prepared in a similar manner.

It should be understood, of course, that the foregoing relates to exemplary embodiments of the invention and that modifications may be made without departing from the spirit and scope of the invention as set forth in the following claims.

What is claimed is:

1. A method for making a cooked shelf stable oat food product, the method comprising:
dispensing oats into a container;
adding hot water to the container;
sealing the container;
waiting for the oats to be immersed in the water;
cooking and sterilizing the sealed container; and
cooling the cooked and sterilized sealed container, wherein
the process is carried out without an acidifier.

2. The method of claim 1, wherein the oats are steel cut oats.

3. The method of claim 1, wherein the hot water has a temperature from about 175° F. to about 212° F.

4. The method of claim 1, wherein the step of cooking and sterilizing the sealed container is conducted at about 248° F. to about 250° F.

5. The method of claim 1, wherein the cooked and sterilized container of oats is shelf stable.

6. The method of claim 1, wherein the container is a semi rigid cup.

7. A cooked shelf stable oat food product made by the process of claim 1.

8. The cooked shelf stable oat food product of claim 7, wherein:
the oats are steel cut oats; and
the container is a semi rigid cup.

9. The cooked shelf stable oat food product of claim 7, wherein:
the hot water has a temperature from about 175° F. to about 212° F.; and
the step of cooking and sterilizing the sealed container is conducted at about 248° F. to about 250° F.
